(19) United States
(12) Patent Application Publication
(10) Pub. No.: US 2021/0357892 A1
(43) Pub. Date: Nov. 18, 2021

(54) METHOD AND SYSTEM FOR PURCHASING DIGITAL MEDIA IN A SECURE ELECTRONIC MARKETPLACE

(71) Applicants: Akanksha Srivastava, Rancho Cordova, CA (US); Satyam Srivastava, Rancho Cordova, CA (US); Raj Kumar Singh Parihar, San Jose, CA (US)

(72) Inventors: Akanksha Srivastava, Rancho Cordova, CA (US); Satyam Srivastava, Rancho Cordova, CA (US); Raj Kumar Singh Parihar, San Jose, CA (US)

(73) Assignee: Akanksha Srivastava, Rancho Cordova, CA (US)

(21) Appl. No.: 16/876,064

(22) Filed: May 17, 2020

(51) Int. Cl. G06Q 20/12; G06Q 30/06; G06Q 30/00

(52) U.S. Cl. CPC G06Q 20/1235; G06Q 30/0185; G06Q 30/0609; G06Q 30/0643

(57) ABSTRACT

A secure electronic marketplace platform is proposed that comprises a server computer equipped with a set of databases, storage systems, payment processing gateway, data analytics engine and a set of user clients to facilitate the sale and purchase of copyrighted digital media entities created by original content creators. Server computer receives a group of one or more copyrighted digital media entities (e.g. digital images) from one group of users and after performing a set of quality assurance related validations, makes them available for purchasing to a second group of users via disclosed platform. By default, limited previews of digital media entities are available via disclosed platform. In addition, users can also purchase a group of one or more digital media entities by registering into the electronic marketplace platform which also requires payment method information. Server computer upon receiving the purchase request verifies the transaction validity, if valid, provides the said user access to view, display across multiple end devices, ability to review, comment and like the purchased digital media entity. In the background, the server computer updates the transaction database to reflect successful transaction and associated creators account gets paid a predetermined fraction of total payment while the remaining fraction goes to service and platform providers (i.e., electronic marketplace, payment processing providers, etc.).

### PRIOR ART

The following is a tabulation of some prior art that presently appears relevant:

U.S. Patents

| Pat. No. | Kind Code | Issue Date | Patentee |
|---|---|---|---|
| 8,024,231 | B2 | Sep. 20, 2011 | Taratino et al. |
| 20050131767 | A1 | Jun. 16, 2005 | Heins |
| 7,343,320 | B1 | Mar. 11, 2008 | Treyz et al. |
| 9,076,169 | B2 | Jul. 7, 2015 | Rempe et al. |
| 20020147683 | A1 | Oct. 10, 2002 | Capobianco et al. |

Foreign Patent Documents

| Foreign Doc. No. | Country Code | Kind Code | Pub. Date | App or Patentee |
|---|---|---|---|---|
| 2772006 | CA | C | 2016 Oct. 18 | Smith et al. |
| 20000048434 | KR | A | 2006 Jul. 20 | Nobuya et al. |

### TECHNICAL FIELD

This application relates to the electronic marketplace of copyright protected digital media for the purpose of selling and purchasing to and from various users and groups.

### BACKGROUND

The present invention relates generally to methods, systems and devices for purchasing digital media entities in digital format from original content creators over a large distributed computer network, such as the Internet. In this age of ubiquitous social media presence and rapid photographs “clicking” aided by high quality cameras with good optics even in handheld devices, a lot of digital content is being created as high quality digital images. Despite this, we still see a lack of a universal distribution platform-device combination where digital images can be purchased and consumed in high resolution without worrying about piracy and undesired proliferation.

Our main objective is “to provide consumers an end-to-end digital platform where they can simply buy high quality digital images to be displayed in their living room like environment from the original content creators at reasonable price and with relative ease.” Our highly interactive digital platform fills the void which exists today due to lack of a cost effective means to securely distribute and consume high resolution digital images without the concern of undesired proliferation and piracy. Embodiments of the present invention are therefore directed to solve the problem of developing a method, system and devices for a secure electronic marketplace where original content creators can sell their copyrighted digital media entities without the fear of piracy and uncontrolled proliferation over the Internet.

### SUMMARY OF THE INVENTION

Our disclosed digital platform consists of three major components: User clients (i.e., mobile app, dedicated display device, various web portals, etc.), a server computer equipped with various web based services, and a data analytics engine. Server computer receives a group of one or more copyright digital media entities (e.g., digital images) from type A users (also known as Artists) and after performing a set of quality assurance validations, makes them available for purchasing to type B users (also known as Patrons) via disclosed electronic marketplace platform. By default, limited previews of digital media entities are available via disclosed platform to all users. In addition, users can also purchase a group of one or more digital media entities by registering into the electronic marketplace platform which also requires payment method information. Server computer upon receiving the purchase request verifies the transaction and, if valid, provides the said user access to view, display across multiple end devices, ability to review, comment and like the purchased digital media entity. In the background, server computer updates the transaction database to reflect successful transaction and associated type A user account gets paid a predetermined fraction of total payment while the remaining fraction goes to service and platform providers (i.e., electronic marketplace, payment processing providers, etc.).

One of the distinct advantages of the present invention is that we provide numerous budding artists a low cost, easily available worldwide electronic marketplace platform where they can sell their copyrighted digital media without the need of setting their own such marketplace and website and solely focus on creating high quality content while also getting specific feedback from a trusting consumer base and patron community. Our invented platform avoids the high overhead cost of individual sales by bundling multiple transactions together and processing payments in regular intervals (e.g., at the end of the month, etc.). Similarly, on the consumer side we avoid charging per purchase and instead keep track of multiple transactions. Once a specified number of transactions are reached, the payment processing incurs to avoid high fixed processing fee associated with individual transactions. Our invented system inculcates a level of trust between our platform, content providers and content consumers. Therefore, in preferred embodiment, individual financial transactions are clubbed together and happen at pre specified time or amount thresholds.

To enable another distinct advantage over current similar platforms, we invent a reward based adaptive credit mechanism to encourage best quality contents (based on Img-Rank) and best artists (Ar-Index) our platform because that is the key to a successful electronic marketplace for digital media. A digital media content which is purchased by numerous users tend to have higher Img-Rank and artists with numerous high Img-Rank content tend to have higher Ar-Index. Img-Rank and Ar-Index together provide a high level of two-tier trust mechanism which fosters a high degree of trust between artists and patrons.

One of the important problems is how do we ensure that Artists and content creators trust our system. In other words, how do we ensure that the number of transactions happened for a given digital media entity are transparent and artists are getting the full benefits. Our solution is to have a “sale” notification based system that whenever someone buys a digital media entity, it automatically notifies the artist. At that point, artists have the choice to either accept or decline the purchase request. In an alternative embodiment, we also have the option to set default where sale happen but then artist can get a weekly or monthly analysis of their sales in terms of how many users bought it, geographically where they are located and other services.

The electronic marketplace disclosed in the present invention is a low-cost, convenient yet secure way for the professional photographers and their patrons to producing and distributing high quality digital media entities (e.g., digital images) without any hassle. The Platform also enables outreach of new and budding photographers and shares a user base across geographical locations worldwide. On the other hand, for consumers, the platform provides an effective means to have access to quality content in their living room like settings without paying a hefty price for it. More importantly, consumers can switch back and forth to various images as opposed to fixed printed content which at present is one of the highly used modes for purchasing high quality images from professional artists and photographers.

The details of one or more embodiments are set forth and described in the accompanying drawings and in the description below. Other features, objects and potential advantages of our invention will become apparent from the description, drawings and claims.

### BRIEF DESCRIPTION OF THE DRAWINGS

FIG. 1 is a block diagram of our disclosed digital marketplace system for digital media distribution and consumption associated with the present invention.

FIGS. 2a and 2b show a typical process by which type A users submit their copyrighted digital media entity to a server computer and upon receiving, a server computer processes them by which after performing various quality checks digital media entity is made available for purchase.

FIGS. 2c and 2d show a typical process by which type B users submit their request to purchase a digital media entity to server computer and upon receiving, a server computer processes it by which after performing various transaction validity checks a set of access controls are granted to said user.

FIG. 3 illustrates various building blocks of invented end device client that can be used by type A and B users to make various kinds of sale and purchase requests to server computer.

FIG. 4 depicts block diagram and internal relational structures or various databases that are managed by the server computer during the course of various sale and purchase process.

FIG. 5 shows a typical image gallery that is organized based on categories and available to users worldwide using user clients such as web browser or dedicated end devices.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. Our invention is about any digital media entity as content but in preferred embodiment it is a digital image. Detailed description will use digital image to describe our invention, processes and methods but can cover other forms of digital media such as digital music, video clips, animation clips, piece of writing and any other forms of digital artwork with certain desirability and intrinsic value.

In our platform we classify our users 101 into two broad categories. Type A user (also known as Artists) is a person, group, organizational entity who uses our platform for selling their copyrighted digital images on our platform. Type B user (also known as Patrons) is a person, group, organizational entity who uses our platform for purchasing and consuming digital images on at least one user clients or display end device.

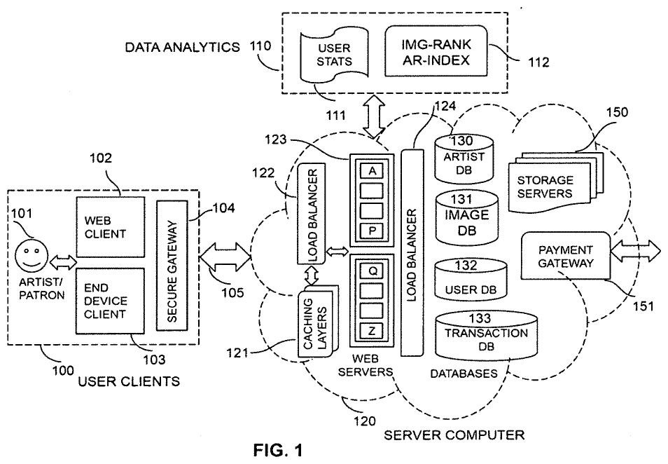

FIG. 1 shows a detailed block diagram of our electronic marketplace platform along with various components. Our proposed digital platform consists of three major components. First component 100 represents a set of user clients which could be user end device client 103 (i.e., mobile app, dedicated display device) or web based client 102 (various web portals for artists and patrons). Second component of our system is computer server 120 and related web based services including storage servers and payment gateway. Third component is data analytics engine 110 which ensures that our platform positively reinforces the best quality content and inherently encourages artists who produce high quality content on a regular basis. In subsequent paragraphs we will describe these three components in detail.

### User Clients (100):

End device client 103 is an end device system (software+hardware combination) where registered patrons can browse, review, like, share, recommend, purchase and display high quality images. It also allows registered patrons to review, like, recommend various artists based on their collections and artwork. Web client 102 is a collection of various web portals which allows potential artists and patrons to browse and view, registered users to review, purchase in addition to browse and view digital images. Web client is primarily meant for creating accounts and registration purposes. It also allows registered artists to upload and sell their digital images to registered patrons.

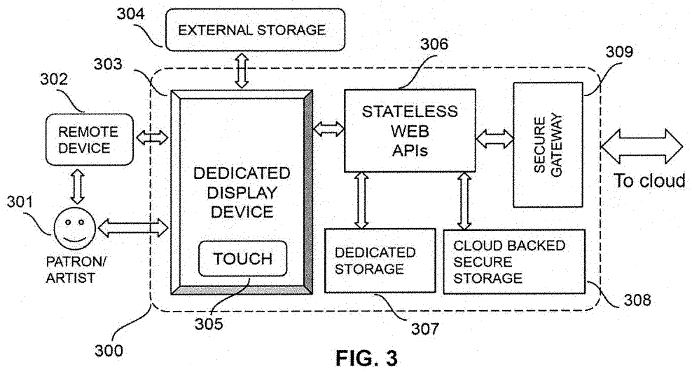

Preferred embodiment of our end device 300 is depicted in FIG. 3. Important components of end device are described in this section. A patron primarily interacts with an end device to experience high quality digital images in their personal setting (e.g., living room, offices, etc.). Dedicated display panel 303 is a high resolution display optionally with high dynamic range (HDR) customized to deliver quality user experience. Our proprietary techniques enhance the user experience tremendously by adjusting the lighting conditions, providing darker contrasts and true black color, sharper images and autocorrection suited for a particular ambience, etc.

In an alternative embodiment, the end display device is controlled from a wireless based either generic or customized remote control device 302. In another alternative embodiment, end device is a generic mobile device running a mobile App (Android or iOS based) created for that particular mobile platform. In another alternative embodiment, the end device is also used to create artists and patrons accounts and facilitate registration. In another alternative embodiment, end device is a handheld mobile device running a dedicated OS meant for purchasing and displaying high quality digital images. In another alternative embodiment, end device is a generic desktop, stationary/fixed computing system running desktop App designed to purchase and display high quality images for that particular platform. In another alternative embodiment, an end device has its own local storage which is used by users to store their local content on device and not visible to other users.

In another alternative embodiment of the end device, the user interaction is also enabled via a highly sensitive touch panel 305 on the dedicated display device. In another alternative embodiment, said touch panel is an addendum to the display device located either on top, bottom or either side of the main screen. Once the image is in full display mode, the touch panel disappears. In another alternative embodiment, the whole display screen doubles as a touch panel for users to interact with the end device.

Said end device has dedicated local storage 307 of limited capacity which is mainly for storing user's personal images and not meant for distribution or sharing. In an alternative embodiment, we also have provisions to purchase cloud storage to save user's images in a backed up environment so that they don't lose their precious memories/images. Cloud backed secure storage 308 is for storing images purchased via our platform which is protected and not allowed to be accessed via any other external means but the display device only. End device also supports plug-and-play external storage devices 304 such as USB or MicroSD cards to either directly view the images on the display or transfer them to the local storage or even to transfer them and store over cloud either free of cost or with minimal charges.

Device software stack and stateless Web APIs 306 are a collection of web based requests, send, receive, acknowledge APIs to interact with the server computer. Secure gateway 309 enables distribution of images over the network to other users by appropriately encrypting and decrypting images and personal information. It also enables computing fast checksum for copyright violation detection purposes. There are three embodiments of our software stack. First is a dedicated operating system (OS) running on a dedicated device. Second is an end device software as an Android/iOS App. Finally, it can be a desktop computer application. In terms of functionality, all of them are similar with very little difference to end users.

There are two major operating modes on the end device beside sleep and idle mode. Online mode is also known as full functionality mode. In this mode, the end device can be used to browse, review, purchase new contents from our platform and assumes Internet connectivity. This requires the user to be registered via web client and have a login which is used to log on using device client. Cloud and end device storage meant for storing purchased content is kept in sync periodically. Device operates with reduced functionality in offline mode but users can still view purchased content. Generally, end devices act as a stand alone system and can only be used to display pre-purchased digital images either stored in the secure local storage (backed by cloud) or from local storage media such as USB drives or SD memory cards.

In the preferred embodiment, web client entity 102 is a collection of web services which does not allow the content to be downloaded to the local storage of the computing system running web clients. In an alternative embodiment, a web client has partial or all capabilities of an end device client which is to browse, review, like, share, recommend, purchase and display digital images. It also allows registered users to review, like, recommend, contract, hire artists. Content submission (copyrighted digital images) can be done via web client. This assumes that the artist has already signed a legal declaration/agreement at the time of the registration and agreed that anything uploaded from his/her account is his/her original content and takes full responsibility. At the time of content submission, we ask artists to provide appropriate “tags”, one caption (optional) and some background information (optional) for each image. This can be used by our algorithms to better match the content with the appropriate consumer base for new uploads. Optional information helps our algorithms to recommend contents to the right set of users. However, at a minimum we need their good quality digital image with assurance of their sole copyright over it and everything else is optional. Our image engine will create tags automatically if there is none and the image then will be linked to those specific galleries.

### Server Computer (120):

Server computer 120 combines and delivers a set of web based services that facilitate distribution, procurement and consumption of digital images in a secure manner to registered users. Server computer handles various types of web based (stateless) APIs and requests coming from patrons (registered and unregistered), artists and other background management tasks such as payment authentication, running analytics, using machine learning and AI based algorithms to suggest classification and tags to the artist who uploaded those images. Server computer consists of various databases, secure storage, web query handling mechanism, load balancers, encryption mechanisms, caching layers, data analytics engine 110 that is responsible for various analytics such as user access pattern, image classification, artist indexing, etc.

Our platform is content centric meaning that a high quality digital image is the primary content and everything around it is highly optimized. In other words, fast read/load access to an image in a reliable and secure manner is our primary objective. Therefore, we utilize various techniques to optimize overall read bandwidths in the system. The central database in our system is Image DB 402 which stores all high quality, vetted images available for consumers to be purchased. For fast access, we store part of Image DB in caching layer or in-memory databases close to consumers. Part of caching layer 121 also stores highly browsed “tags” and a subset of thumbnails (compressed versions of images) of highly ranked and desired images. This allows users to have fast access to the content that they are more likely to “like” and eventually purchase. At the time of a new image upload, an entry is created in the Image DB if the image meets the basic quality checks (pixels, size, nudity-free, etc.). A link to the artist who uploads the image is created as well and this is recorded in Transaction DB 407 among many other transactional information and metadata. Each time a patron buys an image, transaction DB is updated along with User DB 400 to reflect this transaction.

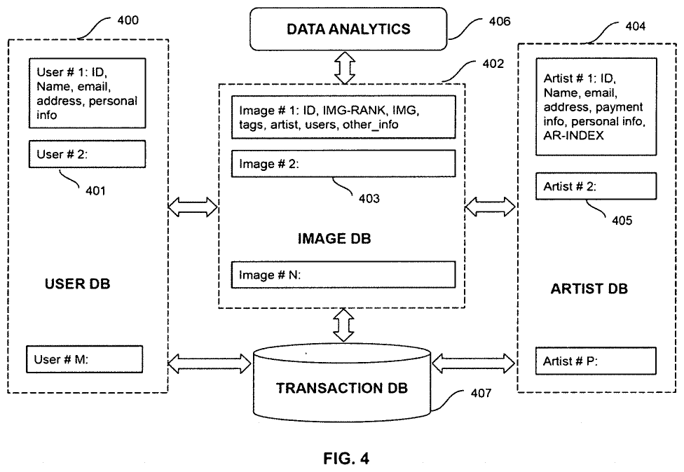

FIG. 4 depicts the interaction and relation of various databases and their internal arrangement in the invented system. Image DB 402 is the main database where a single entry 403 represents a single digital image. We build enough metadata info around it to link it to an artist, customers who bought it, tags that apply to it, its thumbnail, etc. Artist and user databases 404 and 400 are secondary databases which have relation to Image database and store artists and users personal information. Transaction DB 407 keeps track of various sale and purchase transactions. Data analytics engine 406 facilitates numerous data analytics such as to allow fast access and browsing capability for highly ranked images, improving the user and artist experiences. Thus, the most popular images based on high Img-Rank get stored and cached in-memory databases and near to users.

Another functionality of transaction database 407 is to bundle transactions and only initiate payment processing requests to payment gateway in some pre-specified intervals. Every user has access to a digital wallet which allows users to transfer money from bank accounts or credit cards at once and transfer “virtual” credits from their digital wallet. We do not allow direct credit card or bank account based payments for small individual purchases. Money first has to be applied to the digital wallet and then it can be used for purchasing images or facilitating any other digital transaction. This is to ensure that the platform incurs low fixed cost overhead for each transaction which could be significant for individual transactions of less than a dollar.

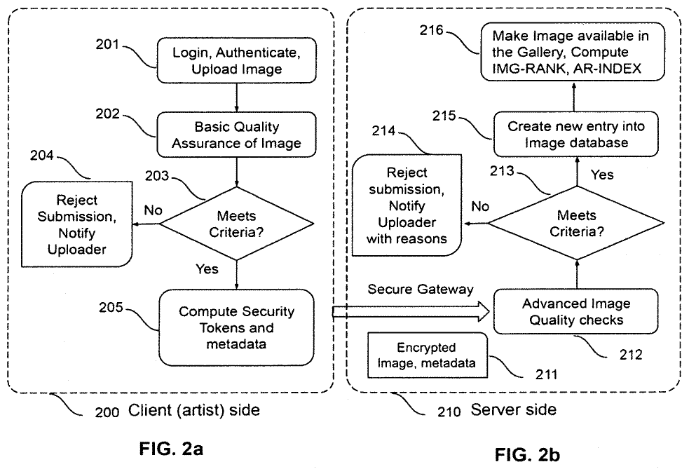

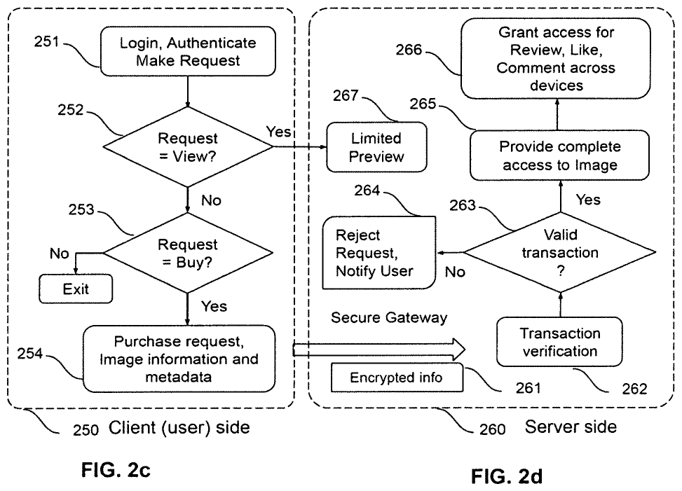

FIG. 2a-d describe how various building blocks of our system work and interact together to facilitate sale and purchase transactions. FIGS. 2a 200 and 2b 210 depict the client side and server side process for submitting original copyrighted digital images by artists. Basic quality assurance is enforced at client side: For example, minimum number pixels in image, maximum file size, certain aspect ratio which are more suitable for a display device in a room settings, etc.

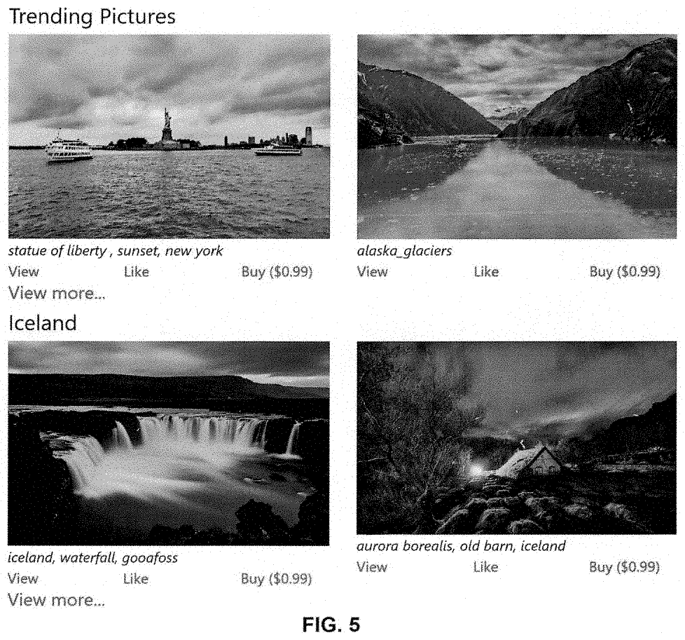

FIG. 2a-b show the process of submitting a digital media content to our platform. Before a digital media can be submitted by an artist, he/she has to register in our system and login using our web clients/portals 201. When an image is uploaded, basic image quality checks 202 such as size and resolution of the image are performed at the user client end. If the image meets those basic standards 203 then security token generation and encryption 205 is performed and an encrypted image is transmitted to the server computer using secure HTTP or SSH requests along with security metadata. If the image does not meet basic quality standards then the request for upload is rejected with appropriate message 204 to the user. Upon receiving the image, the server computer performs advanced image quality checks 212 such as potential copyright violation as well as nudity detection. If the image passes these checks 213 then it is added into the main Image Database 215 and is made part of various image galleries. After some analysis of the image, it is also added into category specific galleries for which one example is shown in FIG. 5. If the image fails the advanced quality checks then the artist is notified 214. Finally, the image is available via various galleries 216 and visible to all patrons.

FIG. 2c-d show the process of purchasing an image 250 which is available on our platform. For purchasing, patrons have to register and create an account and also have to provide a payment method. Payment method is not needed for preview requests. After authentication step 251, the user client determines whether the request is for view only 252 or for purchase 253. If it is only a preview request then the server computer provides a limited preview 267 of the requested image. If the request is for purchase then the user client records the request and generates security metadata for the requested image 254. Upon receiving the purchase request 261 on the server computer, it verifies the transaction for correct information such as enough “virtual” credit balance 262. If the transaction is valid then the server computer allows said user to access the high resolution image 265 on their end device client. Server computer also grants access to said user across multiple devices and ability to comment, like and review image 266. If the transaction is not valid, then the server computer notifies the user with appropriate applicable reasons 264 and rejects the purchase request.

### Data Analytics (110):

We invented a novel reward based adaptive ranking mechanism to encourage best quality contents and best artists on our platform because that is the key ingredient for a successful electronic marketplace platform. This is also in line with our observation that there are very few selected images which make for a good display in a living room type of settings. Selected set will ensure a reduced storage requirement and by ensuring that all images reside in caching layers, we provide high availability and fast access. Overall goal here is to ensure that a large majority of our artists rely on good quality selected content as opposed to relying on a large quantity to be profitable.

Img-Rank is the central metric in our system which determines how important and popular an image is. Ideally, in a large scale system (with millions of images and millions of users) we would like to provide high availability and super-fast access to these images. Therefore, it is critical to define Img-Rank and how it is computed. It is fundamentally very different from a set of random users giving “thumbs up” to an image as it happens in many of the social media platforms where a post or a lower quality picture might receive more hits because of more followers of the uploader and therefore become more popular.

Our Img-Rank algorithm assigns more weight on trust and stakeholders. It is a number which can be anything from 1 to a positive number. Higher the number the better and represents the higher likelihood of an image being purchased by a new user. Some of the factors that influence the Img-Rank score are:
Artist: at the time of image upload it gets 1 point which comes from the artist. This is the only time an artist can influence the Img-Rank score directly.
Each time someone purchases an image it gets additional 1 point. For example, if 100 people bought the image then the new updated Img-Rank score will be 101.
Every “like/share/recommend” by a user who didn't purchase the image gives 0.1 point.
A “recommendation” by a user who purchased the image assigns 1 point.
Every day the image is displayed by a user on his device gets awarded 1 point as well.
A user's weight score could be anywhere from 0.1 to 1 depending upon whether they are beginners or pros with high trust in the system.
   Overall, Img-Rank is a function of the aforementioned factors and activities and can be represented as:
Img-Rank:=F(#users, #hrs_image_was_displayed, #ranks_of_users, #rank_of_artist, #likes/shares, #recommends, #misc)

Analytics engine 112 computes Img-Rank each day for top 10% images and updates every night. For the remaining 90% of the images, it is computed every week and updated then. Our device side client polls the end device every few minutes and builds a histogram of which images were displayed during the day. This is collected once per day and is used to update the Img-Rank score. We need to get that data from the device client which is being collected by the device side application and only the consolidated info is transmitted to the server in periodic manner. By the design of it, Img-Rank is a sophisticated, spoof-resistant metric because it will determine the “true” popularity of an image as opposed to just “like” or “recommend” by a set of random users which can be easily bought or influenced. Also, we have rankings of users to determine the quality of the content by factoring that into Img-Rank score.

Our platform is inherently designed to encourage artists who create best quality content on a regular basis. Each time an image has a sale, it results in updating the Ar-Index for that particular artist. In a simple form, Ar-Index represents a number for a given artist who has sold at least N of his images to N users (much like H-index in the scientific community). In our platform, Ar-Index N represents the fact that an artist has at least N images whose Img-Rank is at least N. To further improve the quality of content and Ar-Index, artist are allowed and encouraged to replace a lower sale image with higher quality image that they think is going to sell better. This is a form of “intelligent” and “adaptive” crowdsourcing by artists. This ensures that only good quality images are available in the system by their own creators for patrons.

We also ensure that artists trust our system and for that our platform has provisions to provide a high level of transparency at per transaction level. In one embodiment, we have an image “sale” notification based system that whenever someone purchases an image it automatically notifies the artist. At that point, artists have the choice to either accept or decline the request. In an alternate embodiment, we also have the option to set default where sale happens but then artists can get a weekly or monthly analysis of their sales in terms of how many users bought it, geographically where they are located and other services. This allows artists to have a transparent view of our system. This is also ensuring that we as a platform provider are more like a fairground management system. Artists/shopkeepers are allowed and enabled to set up and showcase (this is more like a digital art gallery) their shops with best products (not everything they have in the store). We regulate prices and control quality but then can not manage every shop individually. For that individual artist is responsible.

### ELEMENT NUMBER LIST

100 User clients to interact with server computer
101 Type A (artist) or Type B (patron) users
102 Web browser or App based client primarily for Type A users
103 Dedicated end display device client primarily for Type B users
104 Secure gateway to communicate with server computer
105 Internet connection using HTTP secure protocol
110 Analytics engine to compute sale and purchase trends and other insights
111 User specific analysis tasks
112 Digital media content and associated artist related analysis tasks
120 Server computer with databases, storages, load balancers, caching layers and other blocks
121 Caching layers to keep high demand digital media content near users
122 Load balancers to route and distribute user traffic and requests to computers evenly
123 Various computers in server system to perform various transactions and tasks
124 Load balancer to manage traffic between server computers and databases
130 Database to keep track of type A users and their personal information
131 Database to record digital media metadata from various type A users
132 Database to keep track of type B users and their personal information
133 Database to record and keep track of various sale and purchase transactions
150 Storage server or disk to store digital media content and other related data
151 Payment gateway to process payments for type A and B users
200 Type A user side process to submit digital media content
201 Type A user to create user login, authentication and upload image step
202 Basic quality checks such as image size, resolution performed on client side
203 Decision box to check whether uploaded images meet certain basic criteria
204 Reject step if images doesn't meet certain basic criteria
205 Compute security related tokens and associated metadata step
210 Server side process to accept digital media from type A users
211 Receive step of encrypted image along with metadata and security related tokens
212 Advanced image quality checks on server side such as copyright and nudity detection
213 Decision box to ensure image meets predefined advanced criteria
214 Server side notification to type A user if image doesn't meet advanced criteria
215 Image entry into global image database for availability on the platform
216 Addition of the image into various galleries and metadata computation
250 Client side process for type B users
251 Login, authentication step for type B users for the purpose of making requests
252 Decision step to check the user request type if it is to view only
253 Decision step to check user request type if it is to purchase a digital media entity
254 Purchase request for an image, compute metadata step
260 Server side process for type B users
261 Receive step for type B users for a purchase request
262 Transaction validate step for type B user requests
263 Decision step to validate the overall purchase transaction
264 Reject and notification step to type B user for invalid transaction
265 Access control step for type B user for valid transaction
266 Additional accesses for review, comment, like and view across multiple devices
267 Limited preview access step to type B user in response to view only request
300 End device client with dedicated display and functionality for user interaction
301 Type A or Type B users
302 Remote controlled device for interaction purposes
303 Dedicated high resolution display device
304 External storage device such as USB or SD memory cards
305 Separate or in-built touch panel for user interaction purpose
306 Set of independent stateless web API to connect with server computer
307 Dedicated storage for users' digital media content
308 Dedicated storage for purchased content, backed up via server computer and cloud
309 Secure gateway to perform encryption and decryption for various requests
400 Database to keep track of type B users and their personal information
401 Specific entry to track type B users
402 Database to record digital media metadata from various type A users
403 Specific entry to keep track of individual digital media content submitted
404 Database to keep track of type A (artist) users and their personal information
405 Specific entry to track type A users' personal information
406 Analytics engine to generate various image and user related analysis
407 Transaction database to keep track of all sales and purchases transactions

What is claimed is:

1. A system for instant purchase and delivery of digital media from an online gallery, comprising:
A server computer configured to:
Enable creation, maintenance, and authentication of user accounts of type A and type B with said accounts comprising: (i) personal and contact information, (ii) payment information, (iii) record of transactions, (iv) storage account
Receive any number of digital media entities from any number of users of type A

2. A system of claim 1, wherein said digital media entities could be professional digital photographs whose copyrights are owned by a photographer even after sending the photographs to said server computer
Perform a first sequence of predetermined quality checks on said digital media entities to determine acceptance

3. A system of claim 1, wherein said quality checks for photographs comprise resolution, size, appropriateness of content, a copyright violation, and falseness of content
Encrypt said digital media entities during a stage of processing selected from a group consisting of storing to the server computer, making a copy, and sending out from the server computer
Store and index said digital media entities into a browseable and searchable online gallery
Receive request from any number of users of type B to display the contents of a subset of said online gallery and deliver the contents of said subset of said online gallery to said user of type B over a computer network

4. A system of claim 1, wherein the delivery for photographs occurs over the world-wide web into the user's software program including web browser
Receive from any number of users of type B, requests to purchase the contents of a subset of said online gallery consisting of one or more digital media entities
Process the purchase request from the user of type B making the request by:
Charging the payment account of said user of type B in the amount of the price of the requested digital media entities as listed in said online gallery

5. A system of claim 1, wherein processing of the payment happens outside of said server computer over a secure payment gateway
Recording the transaction and crediting a predetermined portion of the payment into the payment account of said user of type A who provided the requested digital media entities to said online gallery
Making a copy of the requested digital media entities into the storage account of said user of type B and optionally encrypting the digital media entities
Deliver the contents of a subset of the storage account of a user of type B over a computer network, consisting of one or more encrypted digital media entities

6. A system of claim 1, wherein the delivery for encrypted photographs occurs over the world-wide web into the user's software program including web browser and are decrypted only when displayed from authenticated software programs
A client to enable a user to perform activities, comprising:
Sending requests to said server computer to create, maintain, and authenticate a user account of type A or type B
Performing a second sequence of predetermined quality checks on a digital media entity to determine acceptance
Sending any number of digital media entities to said server computer for storage into the online gallery
Sending requests to said server computer to retrieve the contents of a subset of said online gallery
Sending request to said server computer to purchase a subset of said online gallery
Receiving from said server computer contents of a subset of said online gallery consisting of one or more digital media entities
Receiving from said server computer contents of a subset of the storage account consisting of one or more digital media entities
Storing the received digital media entities on a restricted local storage unit
Decrypting and displaying the received digital media entities to the user

7. A system of claim 1, wherein said client is a software program running on a personal computing device

8. A system of claim 1, wherein said client is a hardware device capable of performing limited computational tasks and through which a user can perform said activities using a provided user interface
Whereby an electronic marketplace is created for transacting in digital media

9. A method for instant purchase and delivery of digital media from an online gallery, comprising:
Performing, via one or more server computer, tasks comprising:
Receiving and processing requests to create, maintain, and authenticate user accounts of type A and type B
Receiving any number of digital media entities from any number of users of type A

10. A method of claim 9, wherein said digital media entities could be professional digital photographs whose copyrights are owned by a photographer even after sending the photographs to said server computer
Performing a sequence of predetermined quality checks on said digital media entities to determine acceptance

11. A method of claim 9, wherein said quality checks for photographs comprise resolution, size, appropriateness of content, a copyright violation, and falseness of content
Encrypting said digital media entities during a stage of processing selected from a group consisting of storing to the server computer, making a copy, and sending out from the server computer
Storing and indexing said digital media entities into a browseable and searchable online gallery
Receiving any number of digital media from any number of users of type A and storing said digital media into a browseable and searchable online gallery
Receiving request from any number of users of type B to display the contents of a subset of said online gallery and delivering the contents of said subset of said online gallery to said user of type B over a computer network

12. A method of claim 9, wherein the delivery for photographs occurs over the world-wide web into the user's software program including web browser
Receiving from any number of users of type B, requests to purchase the contents of a subset of said online gallery consisting of one or more digital media entities
Processing the purchase request from the user of type B making the request by:
Charging the payment account of said user of type B in the amount of the price of the requested digital media entities as listed in said online gallery

13. A method of claim 9, wherein processing of the payment happens outside of said server computer over a secure payment gateway
Recording the transaction and crediting a predetermined portion of the payment into the payment account of said user of type A who provided the requested digital media entities to said online gallery
Storing a copy of the requested digital media entities into the storage account of said user of type B and optionally encrypting the digital media entities
Delivering the contents of a subset of the storage account of a user of type B over a computer network, consisting of one or more encrypted digital media entities

14. A method of claim 9, wherein the delivery for encrypted photographs occurs over the world-wide web into the user's software program including web browser and are decrypted only when displayed from authenticated software programs
Enabling, via an agent, a user to perform tasks comprising:
Sending requests to said server computer to create, maintain, and authenticate a user account of type A or type B
Performing a second sequence of predetermined quality checks on a digital media entity to determine acceptance
Sending any number of digital media entities to said server computer for storage into the online gallery
Sending requests to said server computer to retrieve the contents of a subset of said online gallery or the storage account of respective user of type B
Sending request to said server computer to purchase a subset of said online gallery
Receiving from said server computer contents of a subset of said online gallery consisting of one or more digital media entities
Receiving from said server computer contents of a subset of the storage account consisting of one or more digital media entities
Storing the received content on a restricted local storage unit
Decrypting and displaying the received digital media entities to the user

15. A method of claim 9, wherein said client is a software program running on a personal computing device

16. A method of claim 9, wherein said client is a hardware device capable of performing limited computational tasks and through which a user can perform said activities using a provided user interface
Whereby an electronic marketplace is created for transacting in digital media

17. An improved method for ranking digital media in an online gallery, comprising:
Storing in a database information about each digital media entity of said online gallery, such information comprising:
A unique identifier for said digital media entity
A unique identifier for a user who added said digital media entity to said online gallery
A set of text tags provided by said user to describe the category of said digital media entity
A first means for determining number of views of said digital media entity in said online gallery over a chosen period of time
A second means for determining number of purchases of said digital media entity in said online gallery over a chosen period of time
Identifying a predetermined number of highest scoring digital media entities where the score is calculated using the elements selected from a group consisting of: number of views of said digital media entity and number of purchases of said digital media entity, over a chosen period of time

18. A method of claim 17, wherein for a gallery of digital photographs, these scores could be used to identify the most-viewed and the most-purchased photographs for recommending to potential buyers visiting the gallery
Storing in a database information about each user of said online gallery, such information comprising:
A unique identifier for said user
A third means for calculating a first average, over a chosen period of time, of number of views of all the digital media entities added by said user to said online gallery
A fourth means for calculating a second average, over a chosen period of time, of number of purchases of all the digital media entities added by said user to said online gallery
Identifying a predetermined number of highest scoring users where the score is calculated using the elements selected from a group consisting of: the first average of number of views and the second average of number of purchases, for each user over a chosen period of time

19. A method of claim 17, wherein for a gallery of digital photographs, these scores could be used to identify the most-popular and the best-selling photographers for recommending to potential buyers visiting the gallery
Whereby the most popular digital media entities can be identified, stored in server caches, and displayed to users of said online gallery in an efficient manner.
